(19) United States
(12) Patent Application Publication
(10) Pub. No.: US 2025/0243102 A1
(43) Pub. Date: Jul. 31, 2025

(54) GLASS ARTICLE AND METHOD FOR MANUFACTURING SAME

(71) Applicant: NIPPON ELECTRIC GLASS CO., LTD., Shiga (JP)

(72) Inventors: Yuji TAKAHASHI, Shiga (JP); Keshiki TERADA, Shiga (JP); Eisuke TAKAO, Shiga (JP)

(21) Appl. No.: 18/708,067

(22) PCT Filed: Nov. 10, 2022
(86) PCT No.: PCT/JP2022/041925

§ 371 Date: May 7, 2024

(30) Foreign Application Priority Data
Dec. 17, 2021 (JP) 2021-205325

(51) Int. Cl. C03B 23/023; C03B 23/025; C03B 23/03; C03B 23/035

(52) U.S. Cl. CPC C03B 23/0235; C03B 23/025; C03B 23/0305; C03B 23/0307; C03B 23/0357

(57) ABSTRACT

Provided is a method of manufacturing a glass article, including a molding step of heating a glass base material with a superheated steam to soften the glass base material, and deforming the softened glass base material.

### TECHNICAL FIELD

The present invention relates to a glass article and a method of manufacturing the same.

### BACKGROUND ART

In recent years, a bent glass sheet including a bent portion bent into a predetermined shape is used in various fields including, for example, a window glass of a vehicle, and a shape of the bent portion is also complicated.

Such a bent glass sheet is obtained by, for example, heating a flat glass sheet in a heating furnace to be softened, and sandwiching the softened glass sheet by an upper die and a lower die to be subjected to press working (see, for example, Patent Literature 1)

### CITATION LIST

Patent Literature 1: JP 2016-141320 A

### SUMMARY OF INVENTION

### Technical Problem

However, for example, when the press working is used, for example, in a case in which a shape of the bent portion is complicated or in a case in which a sheet thickness of the glass sheet is small, there is a risk in that the glass sheet inappropriately comes into contact with the upper die or the lower die at the time of mold clamping or mold opening, with the result that scratches are formed in the glass sheet, or the glass sheet is broken.

As another method of processing the glass sheet, for example, it is conceivable to heat the glass sheet with a burner. However, when the burner is used, soot adheres on the glass sheet or in a production facility, with the result a purification processing is required, and thus, the bent glass sheet cannot be efficiently manufactured.

The present invention has been made in view of the above-mentioned circumstances, and has an object to manufacture the glass article efficiently while preventing scratches or breakage from being caused at the time of molding of the glass article.

### Solution to Problem

(1) The present invention has been made in order to solve the above-mentioned problems, and there is provided a method of manufacturing a glass article, comprising a molding step of heating a glass base material with a superheated steam to soften the glass base material, and deforming the softened glass base material.

According to such a configuration, in the molding step, the superheated steam is jetted onto the glass base material. The superheated steam can efficiently transfer heat to the glass base material as compared with general hot air or the like, thereby easily softening the glass base material. Accordingly, the glass article can be efficiently manufactured while preventing scratches or breakage from being caused on the glass article.

Further, in the case of using the superheated steam in the molding step, the superheated steam does not generate soot unlike the burner. Thus, there is also an advantage in that cleanliness of the glass article after the molding step is high. Further, the superheated steam is non-oxidizing steam, thus not leading to oxidization of the production facility.

The superheated steam has a high heat conductivity, thereby being capable of efficiently manufacturing the glass article as compared with a related-art heater. The superheated steam used in the present invention has a proportional relationship in distance and heat quantity with the glass base material. Thus, as compared with the related-art heater, the heating temperature with respect to the glass base material can be adjusted easily. In contrast, in the case of using the burner which is a related-art heater, a hot spot and a cool spot are present in flame, and thus adjustment of the heating temperature is difficult.

(2) In the configuration of the above-mentioned item (1), in the molding step, the glass base material may be deformed by a wind pressure of the superheated steam. Accordingly, the glass base material can be deformed efficiently.

(3) In the configuration of the above-mentioned item (1) or (2), the superheated steam may be jetted in a range wider than a portion of the glass base material which is to be deformed.

In this manner, not only the portion in which the glass base material is to be molded, but also the vicinity thereof is softened. As a result, the periphery of a molding portion of the glass article is also brought into a deformable state, thereby being capable of suppressing breakage of the glass article due to excessive tension applied to the periphery of the molding portion of the glass article.

(4) In the configuration of any of the above-mentioned items (1) to (3), it is preferred that a temperature of the superheated steam be equal to or more than a softening point of the glass base material.

In this manner, the glass sheet can be softened only by jetting of the superheated steam without additionally providing a part configured to heat the glass base material.

(5) In the configuration of any of the above-mentioned items (1) to (4), the method of manufacturing a glass article may further comprise an arranging step of arranging the glass base material on a lower die before the molding step. The lower die may comprise a placement surface configured to support the glass base material, and a space portion configured to allow deformation of a part of the glass base material. The space portion may have an opening surrounded by the placement surface. In the molding step, under a state in which the glass base material is supported by the placement surface, the superheated steam may be jetted onto the glass base material from above the lower die to soften a part of the glass base material located within a range of the opening, and the softened part may be deformed due to the own weight of the softened part.

When a part of the glass base material located within a range of the opening of the lower die is deformed as described above, a part of the glass base material can be molded without bringing the lower die into contact with a part of the glass base material.

(6) In the configuration of the above-mentioned item (5), the arranging step may comprise a step of overlaying a mask member on the glass base material arranged on the placement surface of the lower die. The mask member may have a through hole. In the step of overlaying the mask member on the glass base material, the mask member may be overlaid on the glass base material such that an inner peripheral edge of the through hole is located on an inner side with respect to an opening edge of the lower die.

When the inner peripheral edge of the through hole of the mask member is arranged on the inner side with respect to the opening edge of the lower die as described above, a part of the glass base material can be molded within the range of the inner peripheral edge of the through hole. Accordingly, a part of the glass base material can be molded without bringing the lower die into contact with a part of the glass base material.

(7) In the configuration of any of the above-mentioned items (1) to (6), the method of manufacturing a glass article may further comprise an arranging step of arranging the glass base material on a lower die before the molding step. The lower die may comprise a molding surface configured to mold the glass base material. The molding surface may be configured to jet the superheated steam in the molding step to soften the glass base material, and then, to suck the glass base material.

In this manner, the softened glass base material is pressed against the molding surface of the lower die due to the own weight and a wind pressure of the superheated steam to be efficiently deformed in conformity to the molding surface. Further, the softened glass base material is pressed against the molding surface also by suction from the molding surface of the lower die. Thus, the softened glass base material is likely to be deformed in conformity to the molding surface. The glass base material may be sucked by the molding surface of the lower die before the glass base material is softened. However, the glass base material is in a state that is difficult to be deformed before being softened, and hence there is a risk in that the glass base material is broken. Thus, it is preferred that the glass base material be sucked before being softened as in the configuration described above.

(8) In the configuration of the above-mentioned item (7), it is preferred that the lower die be controlled in temperature.

(9) In the configuration of the above-mentioned item (8), it is preferred that the lower die be controlled in temperature to a softening point of the glass base material or less.

The glass base material is likely to be deformed as the temperature of the glass base material is higher. Meanwhile, a contact trace is liable to be formed on the contact portion of the glass base material and the lower die. Further, when the temperature difference between the surface of the lower die and the glass base material exceeds a certain range, the glass base material comes into contact with the surface of the lower die at the time of bending, and hence there is a risk in that the glass base material is broken. Thus, it is preferred that the lower die be controlled in temperature to suppress a contact trace on the glass base material and breakage as in the configuration described above.

(10) In the configurations of the above-mentioned items (7) to (9), the lower die may comprise a restricting mechanism configured to restrict lateral displacement of the glass base material. The glass base material may be deformed under a state in which the lateral displacement of the glass base material with respect to the lower die is restricted by the restricting mechanism. In this manner, the glass base material can be accurately deformed by restricting the position of the glass base material.

(11) In the configuration of the above-mentioned item (10), the lower die may comprise a placement surface on which a part of the glass base material is to be placed. The restricting mechanism may suck a part of the glass base material by the placement surface to fix the glass base material.

(12) Alternatively, in the configuration of the above-mentioned item (10), the lower die may comprise a placement surface on which a part of the glass base material is to be placed. The restricting mechanism may press a part of the glass base material against the placement surface by a pressing member to fix the glass base material.

In this manner, when the glass base material is to be deformed, a part of the glass base material can be prevented from coming off from the placement surface. Accordingly, the glass base material can be accurately deformed.

(13) In the configuration of any of the above-mentioned items (1) to (12), in the molding step, the glass base material arranged in a heating furnace may be softened with the superheated steam supplied into the heating furnace, and the softened glass base material may be deformed.

(14) The present invention has been made in order to achieve the above-mentioned object, and there is provided a glass article having a surface. A hydrogen atom concentration profile obtained by measuring a hydrogen atom concentration in a depth direction from the surface comprises an inclined portion that decreases in the hydrogen atom concentration with respect to the depth direction in a range in which the depth is larger than 1.5 μm.

(15) In the configuration of the above-mentioned item (14), in a range up to a depth of 1.5 μm from the surface, the hydrogen atom concentration profile may have an inclined portion in which a degree of decrease in the hydrogen atom concentration with respect to the depth direction is larger than in the inclined portion.

(16) In the configuration of the above-mentioned item (14) or (15), the surface may comprise a bent portion, and in at least the bent portion, a hydrogen atom concentration profile obtained by measuring a hydrogen atom concentration in the depth direction from the surface may have an inclined portion in which the hydrogen atom concentration decreases with respect to the depth direction in a range in which the depth is larger than 1.5 μm.

### Advantageous Effects of Invention

According to the present invention, the glass article can be efficiently manufactured while preventing scratches and breakage from being caused at the time of molding the glass article.

### BRIEF DESCRIPTION OF DRAWINGS

FIG. 1 is a side view for illustrating an overall configuration of a manufacturing apparatus to be used in a method of manufacturing a glass article according to a first embodiment of the present invention.

FIG. 2 is a plan view for illustrating a periphery of a lower die of the manufacturing apparatus of FIG. 1 in an enlarged manner.

FIG. 3 is a sectional view taken along the line III-III of FIG. 2.

FIG. 4 is a plan view for illustrating a main part of a manufacturing apparatus to be used in a method of manufacturing a glass article according to a second embodiment of the present invention in an enlarged manner.

FIG. 5 is a sectional view taken along the line V-V of FIG. 4.

FIG. 6 is a plan view for illustrating a main part of a manufacturing apparatus to be used in a method of manufacturing a glass article according to a third embodiment of the present invention in an enlarged manner.

FIG. 7 is a sectional view taken along the line VII-VII of FIG. 6.

FIG. 8 is a sectional view for illustrating a main part of a manufacturing apparatus to be used in a method of manufacturing a glass article according to a fourth embodiment of the present invention in an enlarged manner.

FIG. 9 is a sectional view for illustrating a main part of a manufacturing apparatus to be used in a method of manufacturing a glass article according to a fifth embodiment of the present invention in an enlarged manner.

FIG. 10 is a sectional view of the glass article.

FIG. 11 is a sectional view for illustrating a main part of a manufacturing apparatus to be used in a method of manufacturing a glass article according to a sixth embodiment of the present invention in an enlarged manner.

FIG. 12 is a graph for showing a hydrogen atom concentration profile of a glass article.

FIG. 13 is a graph for showing a hydrogen atom concentration profile of a glass article.

### DESCRIPTION OF EMBODIMENTS

In the following, embodiments of the present invention are described with reference to the drawings. X, Y, and Z in the drawings represent an orthogonal coordinate system. An X direction and a Y direction are horizontal directions, and a Z direction is a vertical direction. In a second embodiment and subsequent embodiments, configurations common to other embodiments are denoted by the same reference symbols, and detailed description thereof is omitted.

In a method of manufacturing a glass article according to the present invention, a glass article is manufactured by softening and deforming a glass base material by heating. In the following embodiments, a case of manufacturing a bent glass sheet comprising a bent portion as a glass article is exemplified. However, the shape of the glass article is not limited to the following embodiments. The present invention can manufacture block-shaped, bar-shaped, and other various glass articles. In the following embodiments, a flat-sheet-shaped glass sheet is exemplified as a glass base material. However, the shape of the glass base material is not limited to the following embodiments.

### First Embodiment

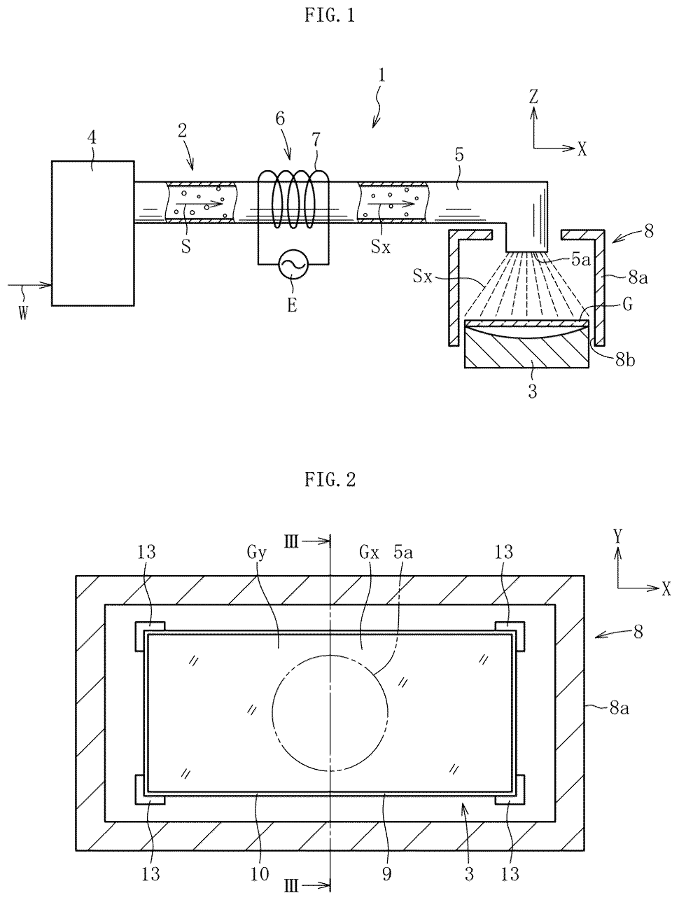

As illustrated in FIG. 1, a manufacturing apparatus 1 to be used in a method of manufacturing a glass article according to a first embodiment of the present invention comprises a superheated steam generating device 2 configured to jet a superheated steam Sx onto a glass sheet G as a glass base material from above, and a lower die 3 configured to mold the glass sheet G into a predetermined shape.

The superheated steam generating device 2 comprises a steam generating device 4 configured to generate a saturated steam S from water W, a transfer pipe 5 configured to allow the saturated steam S generated in the steam generating device 4 to flow therethrough, and a superheating device 6 configured to bring the saturated steam S flowing through the transfer pipe 5 into a superheated state to generate the superheated steam Sx. The superheated steam Sx means a high-temperature steam obtained by further heating the saturated steam S generated by boiling the water W. Thus, the superheated steam Sx does not substantially contain air.

As the steam generating device 4, for example, a boiler or the like can be used. The steam generating device 4 may comprise, in addition to the boiler for heating the water W, a pressure reducing device in order to efficiently generate the saturated steam S from the water W supplied to the steam generating device 4.

In this embodiment, as the superheating device 6, a device configured to inductively heat the transfer pipe 5 is used. That is, the superheating device 6 comprises a coil 7 wound around an outer periphery of the transfer pipe 5, and a power supply E configured to allow current to flow through the coil 7. Accordingly, the inductively heated saturated steam S flowing through the transfer pipe 5 is brought into a superheated state. The method of heating by the superheating device 6 is not particularly limited, and may be, for example, a method of heating the saturated steam S with a burner, a heater, by energization heating, or the like through intermediation of the transfer pipe 5.

The transfer pipe 5 is a metal pipe, and comprises jet port 5a configured to jet the superheated steam Sx.

It is preferred that the temperature of the superheated steam Sx be a temperature equal to or more than a softening point of the glass sheet G. Here, the softening point is a temperature at which the glass sheet G is softened and starts deforming when the glass sheet G is heated. Specifically, the temperature of the superheated steam Sx is preferably from 200° C. to 1,200° C., more preferably from 600° C. to 1,180° C., still more preferably from 650° C. to 1150° C., further preferably from 700° C. to 1, 100° C. Here, the temperature of the superheated steam Sx is, for example, a temperature of the superheated steam Sx at the jet port 5a of the transfer pipe 5.

The distance between the jet port 5a of the transfer pipe 5 and the glass sheet G is preferably from 3 cm to 100 cm, more preferably from 5 cm to 20 cm.

These conditions of the superheated steam Sx can be appropriately changed depending on a sheet thickness, a composition, and the like of the glass sheet G.

The periphery of the jet port 5a is covered with a cover member 8. The cover member 8 is formed into, for example, a tubular shape with a material such as metal such as stainless steel, heat resistance brick, or ceramic. The cover member 8 comprises a wall portion 8a configured to partition a space between the lower die 3 and the jet port 5a, and an opening portion 8b which is formed at a lower portion of the wall portion 8a and through which the lower die 3 can be inserted. In this embodiment, a range from the jet port 5a to the lower die 3 is covered with the cover member 8 so that heat of the superheated steam Sx jetted from the jet port 5a can be efficiently transferred to the glass sheet G supported on the lower die 3.

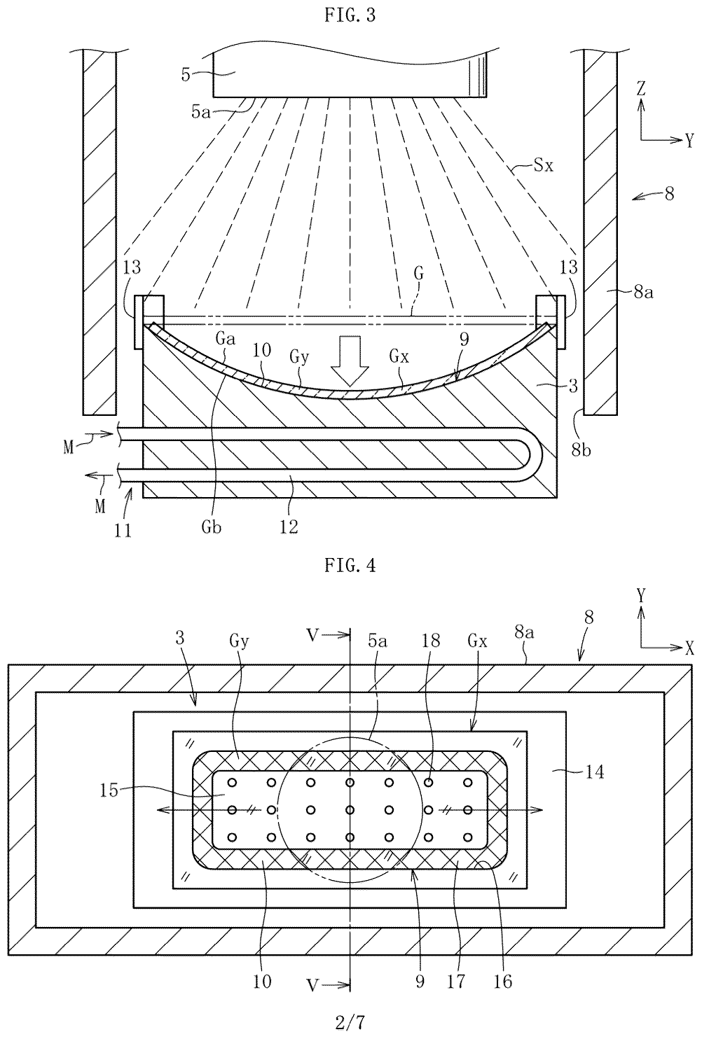

As illustrated in FIG. 2 and FIG. 3, the lower die 3 is made of metal, and comprises a molding surface 9 on an upper surface thereof. In this embodiment, an entire upper surface of the lower die 3 is the molding surface 9, and an entire molding surface 9 is a bending portion 10 for forming a bent portion Gy on the glass sheet G. Specifically, the bending portion 10 forms a substantially spherical recessed portion curved with respect to two directions (the X direction and the Y direction in FIG. 2) orthogonal to each other within a horizontal plane. The lower die 3 may be made of ceramic or heat-resistant glass instead of metal.

The lower die 3 comprises a temperature control mechanism 11. In this embodiment, the temperature control mechanism 11 comprises a cooling pipe 12 arranged inside the lower die 3, and a cooling medium (for example, water or air) M flowing through the cooling pipe 12. The configuration of the temperature control mechanism 11 is not particularly limited as long as the temperature control mechanism 11 can control the temperature of the glass sheet G. For example, when the temperature control mechanism 11 heats the lower die 3, a heater (not shown) may be arranged inside the lower die 3, or both a cooling mechanism and a heating mechanism may be provided inside the lower die 3. Further, the temperature control mechanism 11 may be omitted.

The lower die 3 comprises, at positions excluding the molding surface 9, side stoppers 13 serving as lateral displacement restricting mechanisms configured to restrict lateral displacement of the glass sheet G. In this embodiment, the side stoppers 13 are arranged at positions corresponding to four corners of the glass sheet G. The positions of the side stoppers 13 are not particularly limited, and may be scattered in a periphery of the glass sheet G arranged on the lower die 3 (positions corresponding to four sides of the glass sheet G).

Next, a method of manufacturing a glass article using the manufacturing apparatus 1 having the configuration described above is described.

The method of manufacturing a glass article according to this embodiment comprises an arranging step of arranging the glass sheet G on the lower die 3, and a molding step of jetting the superheated steam Sx onto the glass sheet G arranged on the lower die 3 from above.

A shape of the glass sheet G is a rectangular shape in this embodiment. However, the shape of the glass sheet G is not particularly limited, and may be, for example, a polygonal shape other than a quadrangular shape or a circular shape (including an ellipse). The sheet thickness of the glass sheet G is, for example, from 0.05 mm to 2 mm. The composition of the glass sheet G is, for example, borosilicate glass, aluminosilicate glass, or soda lime glass. The softening point of the glass sheet G is, for example, from 700° C. to 1,000° C. The glass sheet G is manufactured by, for example, a down-draw method such as an overflow down-draw method, a slot down-draw method, or a re-draw method or a float method. Among the methods, the overflow down-draw method is preferable in that surfaces on both sides are fire-polished surfaces and high surface quality is achieved.

In the arranging step, the glass sheet G is arranged on the lower die 3. In this state, the glass sheet G is positioned under a state in which lateral displacement is restricted by the side stoppers 13. The glass sheet G supported by the lower die 3 may be elastically deformed slightly due to the own weight.

As illustrated in FIG. 3, in the molding step, the superheated steam Sx is jetted from above to soften the glass sheet G. In this embodiment, the superheated steam Sx is jetted onto substantially an entire surface of the glass sheet G. The superheated steam Sx can transfer heat efficiently to the glass sheet G as compared to a normal heated steam (for example, a saturated steam). Thus, the glass sheet G can be softened in a short time (for example, from 1 second to 120 seconds). It is considered that this is due to a combined effect of condensation heat transfer, convection heat transfer, and radiation heat transfer. Further, in the case of using the superheated steam Sx in the molding step, the superheated steam Sx does not generate soot unlike a burner which is a related-art heater, and hence has an advantage in that cleanliness of the glass sheet G after bending is high. Further, the superheated steam Sx does not substantially contain air and is non-oxidizing steam, and hence has a small influence on the quality of the glass sheet G after bending, and has a small risk of causing an accident such as a fire during bending. Temperature control is easier in the superheated steam Sx than an internal space inside a heating furnace, and hence the reproducibility of the glass sheet G after bending is also high. When bending of the glass sheet G is performed using the superheated steam Sx, there is also an advantage in that strain remaining on the glass sheet G after bending is small.

The softened glass sheet G is pressed downward due to the own weight of the glass sheet G and a wind pressure of the superheated steam Sx to come into contact with the molding surface 9 of the lower die 3. As a result, the softened glass sheet G is deformed in conformity to the molding surface 9 to manufacture a bent glass sheet Gx comprising the bent portion Gy that matches a shape of the bending portion 10. That is, in this embodiment, the bent portion Gy is formed on an entire bent glass sheet Gx, and a shape of the bent portion Gy is a substantially spherical shape curved with respect to the two directions (the X direction and the Y direction in FIG. 2) orthogonal to each other within the horizontal plane. The bent portion Gy comprises a first surface Ga (inner surface) deformed in a recessed shape through contact of the superheated steam Sx, and a second surface (outer surface) having a protruding shape located on a side opposite to the first surface Ga. The first surface Ga is a recessed curved surface formed without contact with the molding surface 9 of the lower die 3. The second surface Gb is a protruding curved surface molded through contact with the molding surface 9 of the lower die 3.

According to this manufacturing method, the bent glass sheet Gx can be efficiently manufactured without using press working. The bent glass sheet Gx as described above is used for, for example, a display of a mobile phone, a window glass of a vehicle, or an instrument panel of a vehicle.

In the molding step, while the glass sheet G is heated with the superheated steam Sx, the lower die 3 is cooled appropriately by the temperature control mechanism 11. In this embodiment, the temperature of the lower die 3 or the temperature of the glass sheet G is measured by any thermometer such as a radiation thermometer, and when the measured temperature exceeds a predetermined threshold value, the lower die 3 is controlled in temperature by the temperature control mechanism 11. Accordingly, the temperature of the glass sheet G is controlled, thereby being capable of suppressing a contact trace at a contact portion between the lower die 3 and the glass sheet G.

### Second Embodiment

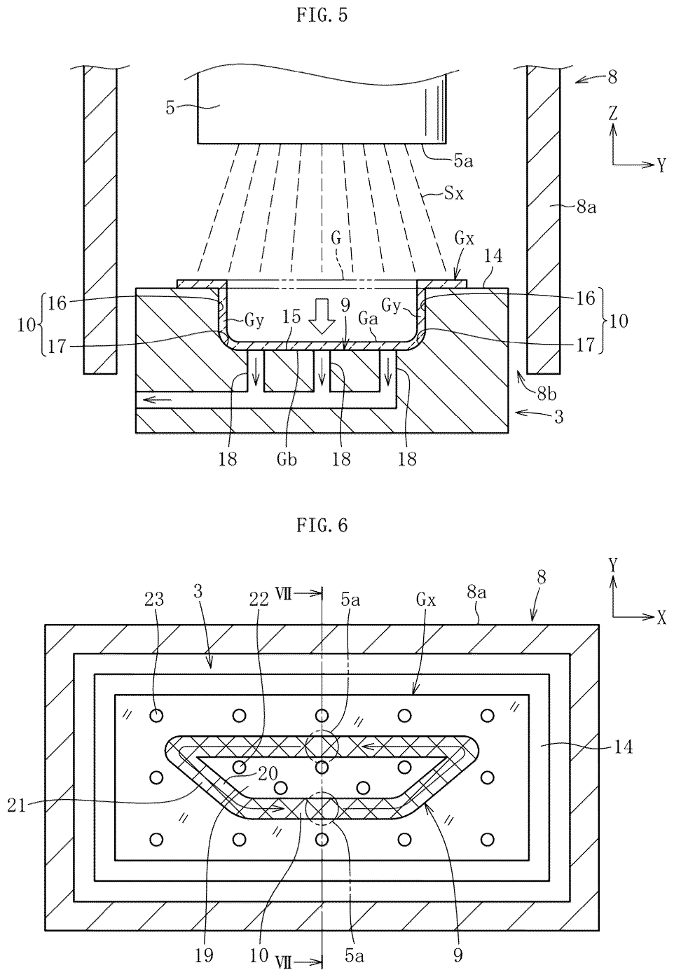

As illustrated in FIG. 4 and FIG. 5, in a method of manufacturing a glass article according to a second embodiment of the present invention, only a center portion within a plane of the glass sheet G is a molding region that comes into contact with the molding surface 9. That is, the lower die 3 comprises the molding surface 9 only at a position corresponding to the center portion (molding region) of the glass sheet G, and a placement surface 14 at a position corresponding to a peripheral edge portion (non-molding region) of the glass sheet G.

The molding surface 9 comprises a bottom surface portion 15 which is a recessed portion having a substantially rectangular shape in plan view and extends in a lateral direction (for example, a horizontal direction), a side surface portion 16 having an upper end coupled to an inner peripheral edge of the placement surface 14 and extending in a longitudinal direction (for example, a vertical direction), and a curved surface portion 17 configured to couple a lower end of the side surface portion 16 and an outer peripheral edge of the bottom surface portion 15 to each other. That is, the bending portion 10 is formed by the side surface portion 16 and the curved surface portion 17. In FIG. 4, for ease of understanding of the position of the bending portion 10, a position corresponding to the bending portion 10 is cross-hatched. A round shape of the curved surface portion 17 can be appropriately changed.

The placement surface 14 is a flat surface (for example, a horizontal surface). As illustrated in FIG. 4, the placement surface 14 is formed so as to surround the periphery of the molding surface 9.

The lower die 3 can be reciprocated in the X direction of FIG. 4 at a position below the jet port 5a of the transfer pipe 5. The transfer pipe 5 jets the superheated steam Sx onto an entire width of the glass sheet G in the Y direction orthogonal to the X direction of FIG. 4 at the position below the jet port 5a. Thus, due to movement of the lower die 3 in the X direction, the superheated steam Sx is jetted onto substantially the entire surface of the glass sheet G. That is, in this embodiment, the superheated steam Sx is jetted in a range wider than the molding region of the glass sheet G. When the lower die 3 and the jet port 5a of the transfer pipe 5 are moved relative to each other, any one of the lower die 3 and the jet port 5a of the transfer pipe 5 may be moved. As a matter of course, for example, an opening area of the jet port 5a of the transfer pipe 5 may be increased, and the superheated steam Sx may be jetted onto substantially the entire surface of the glass sheet G without moving the lower die 3 relative to the jet port 5a of the transfer pipe 5. Alternatively, the superheated steam Sx may be jetted only onto a portion corresponding to the molding surface 9 in the glass sheet G.

The lower die 3 comprises a plurality of suction holes 18 at the bottom surface portion 15 of the molding surface 9. Suction holes may be formed in the bending portion 10. However, in this embodiment, the suction holes are not formed in the bending portion 10. That is, the bending portion 10 is a continuous surface without a recess.

In this manufacturing method, after the superheated steam Sx is jetted to soften the glass sheet G, gas between the glass sheet G and the molding surface 9 is sucked from the plurality of suction holes 18. Accordingly, the softened glass sheet G is pressed against the molding surface 9 also by suction from the suction holes 18 of the lower die 3 in addition to the own weight and a wind pressure of the superheated steam. Thus, the softened glass sheet G is likely to be deformed in conformity to the molding surface 9, and the bent glass sheet Gx comprising the bent portion Gy matching the shape of the bending portion 10 can be efficiently manufactured. In this embodiment, the bent glass sheet Gx comprises a recessed portion at the center portion due to the bent portion Gy matching the shape of the bending portion 10 (the side surface portion 16 and the curved surface portion 17).

### Third Embodiment

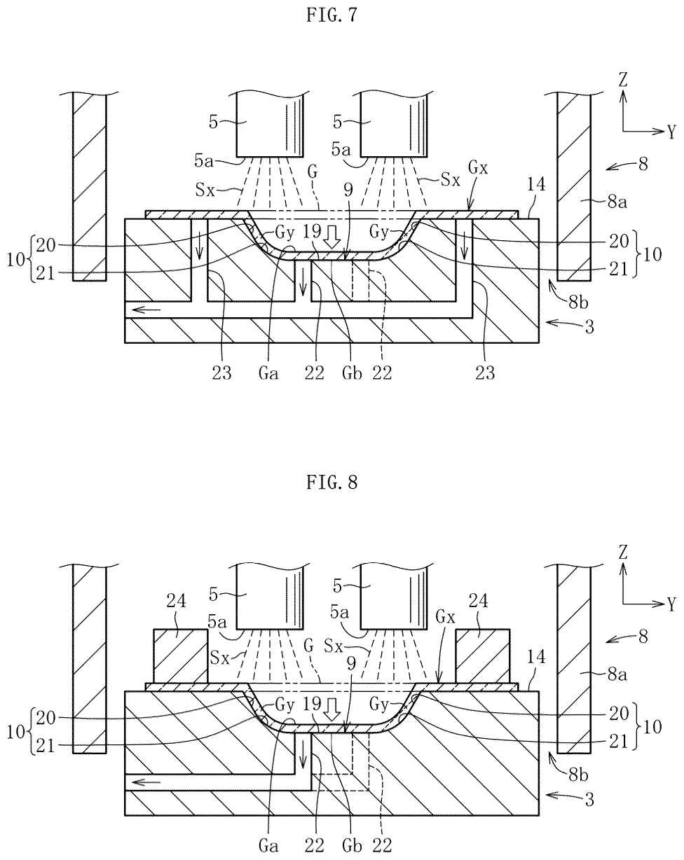

As illustrated in FIG. 6 and FIG. 7, in a method of manufacturing a glass article according to a third embodiment of the present invention, only a center portion within a plane of the glass sheet G is a molding region. That is, similarly to the second embodiment, the lower die 3 comprises the molding surface 9 only at a position corresponding to the center portion (molding region) of the glass sheet G, and a placement surface 14 at a position corresponding to a peripheral edge portion (non-molding region) of the glass sheet G.

The molding surface 9 comprises a bottom surface portion 19 which is a recessed portion having a substantially trapezoidal shape in plan view and extends in the lateral direction (for example, the horizontal direction), an inclined surface portion 20 having an upper end coupled to the inner peripheral edge of the placement surface 14 and extending in a direction inclined with respect to the vertical direction, and a curved surface portion 21 configured to couple a lower end of the inclined surface portion 20 and an outer peripheral edge of the bottom surface portion 19 to each other. That is, the bending portion 10 is formed by the inclined surface portion 20 and the curved surface portion 21. In FIG. 6, for ease of understanding of the position of the bending portion 10, a position corresponding to the bending portion 10 is cross-hatched. An inclination angle of the inclined surface portion 20 and a round shape of the curved surface portion 21 can be appropriately changed.

The jet port 5a of the transfer pipe 5 may be one. However, in this embodiment, a plurality of jet ports 5a are formed. Each jet port 5a is movable along the bending portion 10 at a position above the glass sheet G. The transfer pipe 5 jets the superheated steam Sx onto the glass sheet G at a position below each jet port 5a. Thus, through movement of each jet port 5a of the transfer pipe 5, the superheated steam Sx is jetted onto a region corresponding to the bending portion 10 and the vicinity thereof. That is, in this embodiment, the superheated steam Sx is locally jetted onto a portion at which shape change from the flat glass sheet G is required. When the lower die 3 and the jet port 5a of the transfer pipe 5 are moved relative to each other, any one of the lower die 3 and the jet port 5a of the transfer pipe 5 may be moved. When the lower die 3 and the jet port 5a of the transfer pipe 5 are not moved relative to each other, the plurality of jet port 5a may be arranged in advance along the bending portion 10.

The lower die 3 comprises a plurality of first suction holes 22 at the bottom surface portion 19 of the molding surface 9, and a plurality of second suction holes 23 serving as lateral displacement restricting mechanisms at the placement surface 14.

In this manufacturing method, after the superheated steam Sx is jetted to soften a part of the glass sheet G, the peripheral edge portion of the glass sheet G is fixed onto the placement surface 14 through suction from the second suction holes 23, and gas between the glass sheet G and the molding surface 9 is sucked from the first suction holes 22. Accordingly, the softened glass sheet G is pressed against the molding surface 9 also by suction from the first suction holes 22 of the lower die 3 in addition to the own weight and a wind pressure of the superheated steam. Further, by suction from the second suction holes 23, the peripheral edge portion of the glass sheet G is fixed to the placement surface 14, the peripheral edge portion of the glass sheet G is thus prevented from coming off. Thus, the softened glass sheet G is likely to be deformed in conformity to the molding surface 9 with high accuracy, thereby being capable of efficiently manufacturing the bent glass sheet Gx comprising the bent portion Gy matching the shape of the bending portion 10. In this embodiment, the bent glass sheet Gx comprises the recessed portion at the center portion due to the bent portion Gy matching the shape of the bending portion 10 (the inclined surface portion 20 and the curved surface portion 21).

Suction start timings by the first suction holes 22 and the second suction holes 23 are the same in this embodiment. However, the suction start timings may be different from each other. For example, before suction of the first suction holes 22 is started, suction of the second suction holes 23 may be started. In this case, under a state in which the glass sheet G is fixed to the placement surface 14 by suction of the second suction holes 23, jetting of the superheated steam Sx may be started, and after the glass sheet G is softened due to the jetting of the superheated steam Sx, suction of the first suction holes 22 may be started.

### Fourth Embodiment

As illustrated in FIG. 8, a method of manufacturing a glass article according to a fourth embodiment of the present invention is different from the third embodiment in the configuration of the lateral displacement restricting mechanism. That is, in this manufacturing method, with a pressing member 24 serving as a lateral displacement restricting mechanism, the peripheral edge portion of the glass sheet G is pressed against the placement surface 14 to fix the glass sheet G to the placement surface 14. In order to generate a pressing force in the pressing member 24, for example, a mechanism such as a fluid cylinder or a linear actuator is used. It is preferred that the position at which the pressing member 24 is arranged be a portion not required to jet the superheated steam Sx to soften the glass sheet G.

### Fifth Embodiment

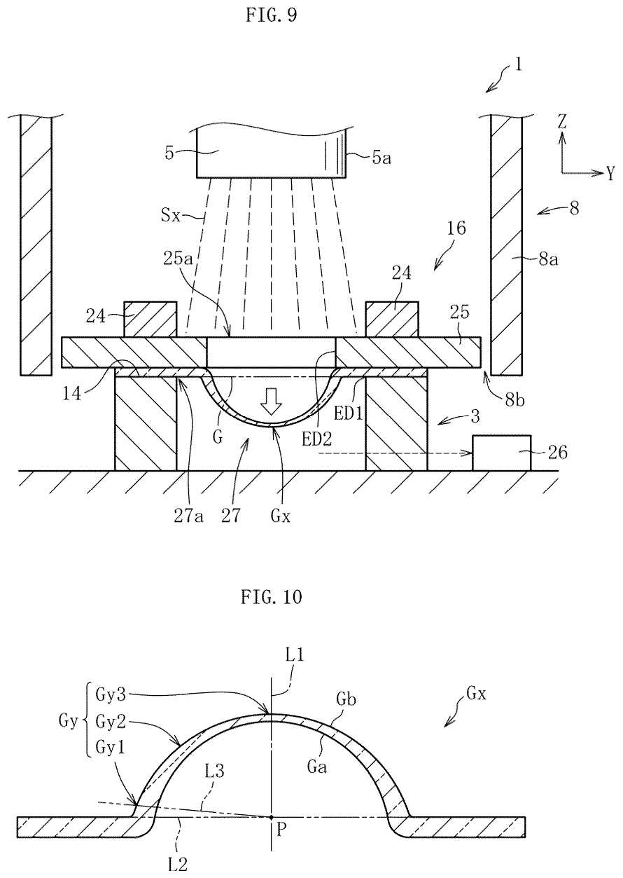

In a fifth embodiment of the present invention illustrated in FIG. 9 and FIG. 10, a manufacturing apparatus 1 for a glass article comprises a pressing member 24 serving as a lateral displacement suppressing mechanism, a mask member 25 arranged so as to be overlaid on the glass sheet G arranged on the lower die 3, and an external force generating device 26 for application of an external force to a part of the glass sheet G.

The lower die 3 according to this embodiment does not comprise the molding surface 9 in the above-mentioned embodiments. The lower die 3 comprises the placement surface 14 configured to support the glass sheet G, and a space portion 27 that comprises an opening 27a surrounded by the placement surface 14 and allows thermal deformation of a part of the glass sheet G. The opening 27a of the space portion 27 comprises an opening edge ED1 having a circular shape. However, the opening 27a may comprise, for example, an opening edge having a polygonal shape such as a triangular shape or a quadrangular shape or an elliptical shape.

The space portion 27 of the lower die 3 may be formed of a through hole, or may be formed of a recessed portion having an inner bottom portion. When the glass sheet G is arranged on the lower die 3, a part of the glass sheet G located within a range of the opening 27a of the space portion 27 is in a non-contact state with the lower die 3.

As illustrated in FIG. 9, the mask member 25 comprises a through hole 25a. The through hole 25a of the mask member 25 comprises an inner peripheral edge ED2 having a circular shape. However, the through hole 25a may comprise, for example, an inner peripheral edge having a polygonal shape such as a triangular shape or a quadrangular shape or an elliptical shape.

It is preferred that the mask member 25 be arranged on the lower die 3 such that at least a part of the inner peripheral edge ED2 of through hole 25a is located on an inner side with respect to the opening edge ED1 of the lower die 3. In this embodiment, in the mask member 25, an entire inner peripheral edge ED2 of the through hole 25a is arranged on the inner side with respect to the opening edge ED1 of the lower die 3.

When an opening area of the opening 27a of the lower die 3 is 100%, the sectional area of the through hole 25a of the mask member 25 is preferably 95% or less, more preferably 80% or less. At least a part of the inner peripheral edge ED2 of the through hole 25a in the mask member 25 is preferably arranged on the inner side by 1 mm or more with respect to the opening edge ED1 of the lower die 3, more preferably arranged on the inner side by 3 mm or more.

It is preferred that the mask member 25 be made of a material having a thermal conductivity of 1 [W/(m·K)] or less at 600° C. As the material forming the mask member 25, for example, ceramic is suitable. The thickness of the mask member 25 is preferably 1 mm or more. The mask member 25 has an outer shape surrounding an entire outer peripheral edge of the glass sheet G.

The jet port 5a of the transfer pipe 5 is arranged above the mask member 25. The jet port 5a can jet the superheated steam Sx in a range wider than the through hole 25a in the mask member 25. Accordingly, the superheated steam Sx can be allowed to pass through an entire range inside the through hole 25a.

The pressing member 24 serving as a lateral displacement restricting mechanism is, for example, placed on an upper surface of the mask member 25, and presses the mask member 25 toward the lower die 3. The pressing member 24 can also be configured to press the lower die 3 against the fixed mask member 25.

As the external force generating device 26, for example, an exhaust device can be used. The exhaust device discharges gas that is present inside the space portion 27 of the lower die 3 to bring an inside of the space portion 27 of the lower die 3 into a negative pressure. Accordingly, a part of the glass sheet G is sucked into the space portion 27 of the lower die 3, thereby being capable of promoting thermal deformation of a part of the glass sheet G. As the exhaust device, for example, a pump using a venturi mechanism is suitable.

In the following, a method of manufacturing a glass article according to this embodiment is described.

In the arranging step, after the glass sheet G is placed on the placement surface 14 of the lower die 3, the mask member 25 is overlaid on the glass sheet G. In this case, an entire inner peripheral edge ED2 in the through hole 25a of the mask member 25 is located on the inner side with respect to the opening edge ED1 of the lower die 3. After that, the pressing member 24 comes into contact with the upper surface of the mask member 25 to press the mask member 25 and the glass sheet G toward the placement surface 14 of the lower die 3. Accordingly, the positional displacement of the glass sheet G sandwiched between the placement surface 14 of the lower die 3 and the mask member 25 can be suppressed.

Next, in the molding step, the superheated steam Sx is jetted from the jet port 5a of the transfer pipe 5. The superheated steam Sx passes through the through hole 25a of the mask member 25 to come into contact with a part of the glass sheet G located within a range of the through hole 25a. Accordingly, a part of the glass sheet G is softened. A part of the softened glass sheet G is deformed downward within a range of the opening 27a in the space portion 27 of the lower die 3 due to the wind pressure of the superheated steam Sx and the own weight. As described above, in the manufacturing method according to this embodiment, the lower die 3 can mold a part of the glass sheet G without contact with the part.

FIG. 10 is an illustration of a bent glass sheet manufactured by the manufacturing method according to this embodiment. The bent portion Gy of the bent glass sheet Gx comprises a base portion Gy1, an intermediate portion Gy2, and a top portion Gy3. In addition, the bent portion Gy comprises the first surface Ga and the second surface Gb molded without contact with the lower die 3.

The base portion Gy1 of the bent portion Gy is continuous with a flat-sheet shaped portion (frame portion) not molded in the bent glass sheet Gx. The intermediate portion Gy2 is located between the base portion Gy1 and the top portion Gy3. The base portion Gy1 means, when a normal line (hereinafter referred to as “first line”) L1 is drawn with respect to the top portion Gy3, and a straight line (hereinafter referred to as “third line”) L3 forming an angle of 5° with respect to a straight line (hereinafter referred to as “second line”) L2 drawn along the flat-sheet shaped portion is drawn from an intersection P of the first line L1 and the second line L2, a portion at which the third line L3 intersects with the bent portion Gy. Further, the top portion Gy3 is a point at which a tangent line drawn with respect to the top portion Gy3 and the second line L2 are parallel to each other.

As illustrated in FIG. 10, the thickness of the bent portion Gy gradually reduces from the base portion Gy1 toward the top portion Gy3. Thus, a thickness Tmin of the top portion Gy3 is smaller than a thickness Tmax of the base portion Gy1.

The thickness Tmax of the base portion Gy1 is, for example, 0.19 mm or more and 1.9 mm or less. The thickness Tmin of the top portion Gy3 is, for example, 0.15 mm or more and 1.0 mm or less. A ratio Tmin/Tmax of the thickness Tmin of the top portion Gy3 to the thickness Tmax of the base portion Gy1 is preferably 0.08 or more and 0.9 or less, more preferably 0.1 or more and 0.8 or less, still more preferably 0.2 or more and 0.5 or less.

The bent glass sheet Gx according to this embodiment is used as, for example, a covering member (lid member) that covers a light emitting element such as an LED with the bent portion Gy in a package having the light emitting element.

### Sixth Embodiment

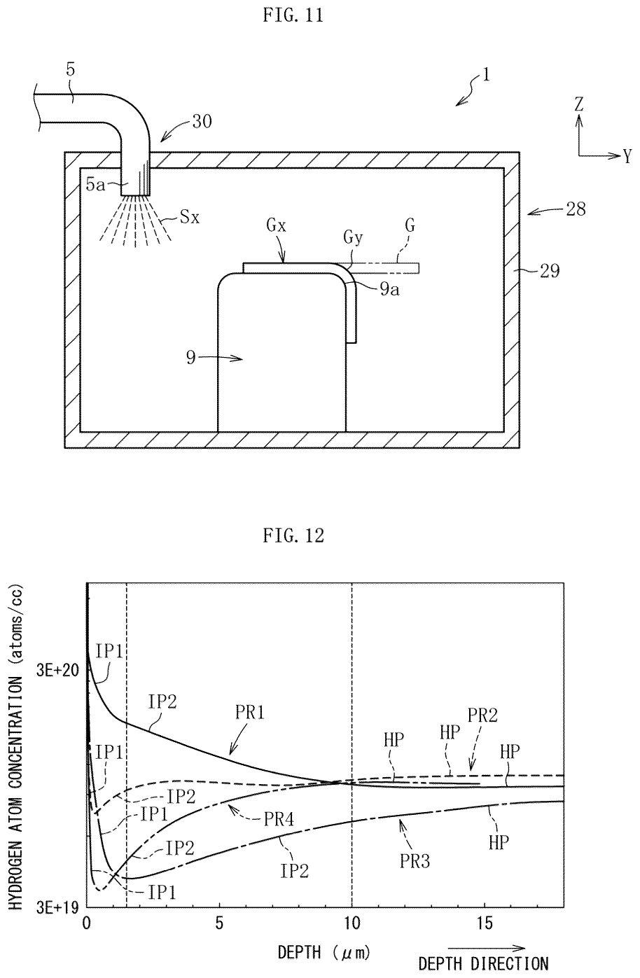

In a sixth embodiment of the present invention illustrated in FIG. 11, a manufacturing apparatus 1 for a glass article comprises a heating furnace 28 configured to heat the glass sheet G as a glass base material. The heating furnace 28 comprises a furnace main body 29 that can be filled with the superheated steam Sx, and a supply unit 30 configured to supply the superheated steam Sx to the furnace main body 29.

The furnace main body 29 has a hollow shape, and has a space capable of accommodating the lower die 3 and the glass sheet G therein. The supply unit 30 is provided at an upper portion of the furnace main body 29. However, the position at which the supply unit 30 is provided is not limited thereto, and the supply unit 30 may be provided at a side portion of the furnace main body 29. In the supply unit 30, the jet port 5a of the transfer pipe 5 is arranged.

The lower die 3 is not located immediately below the supply unit 30, but is installed at a bottom portion of the furnace main body 29 at a position away from the supply unit 30.

In the method of manufacturing a glass article according to this embodiment, in the molding step, by the superheated steam supplied from the supply unit 30 into the furnace main body 29, the space in the furnace main body 29 can be set at the temperature at which the glass sheet G can be softened. The glass sheet G supported on the lower die 3 in the furnace main body 29 is heated with the superheated steam supplied into the furnace main body 29 to be softened. A part of the softened glass sheet G bends due to the own weight to be molded into a predetermined shape in conformity to the molding surface 9 of the lower die 3.

As a result of intensive studies, the inventors have found that, when a glass article is manufactured by the manufacturing method according to the present invention, a hydrogen atom concentration profile obtained by measuring a hydrogen atom concentration from the surface of the glass article in a depth direction is different from that of a related-art glass article.

FIG. 12 is a graph for comparing the hydrogen atom concentration profile (superheated steam temperature of 950° C.) of the glass article according to the present invention (alumino silicate glass T2X-1 (manufactured by Nippon Electric Glass Co., Ltd.)), thickness of 0.7 mm, softening point of 862° C., not hardened) and a hydrogen atom concentration profile of the related-art glass article (alumino silicate glass T2X-1 (manufactured by Nippon Electric Glass Co., Ltd.)) to each other. In FIG. 12, the horizontal axis represents a depth (μm) from the surface of the glass article. “0” in the horizontal axis means a position of the surface (first surface formed through contact of the superheated steam Sx) of the glass article. In FIG. 12, the vertical axis atom concentration (atoms/cc) of the glass article, which is logarithmically represented. The hydrogen atom concentration of the glass article can be measured by Dynamic SIMS (secondary ion mass spectrometry).

As the measuring conditions of the dynamic SIMS, for example, ADEPT1010 manufactured by ULVAC-PHI, Incorporated. is used as a measuring device, Cs+ is set as primary ion species, 5 kV is set as a primary ion acceleration voltage, negative is set as a secondary ion polarity, and a neutralization gun is used.

In the following, the hydrogen atom concentration profile of the glass article manufactured by the present invention is referred to as a first profile, which is denoted by a reference symbol PR1 and indicated by the solid line in FIG. 12. This profile is measured as follows. That is, a crater depth after the measurement by the dynamic SIMS is actually measured, and a sputtering rate of the primary ion is obtained. Then, the time is converted into a depth using the sputtering rate. Fine noise may be generated when this profile is measured, and such noise is removed by smoothing. Further, a hydrogen atom concentration profile of a glass article manufactured using a gas burner as a related-art heater is referred to as a second profile, which is denoted by a reference symbol PR2 and indicated by the dot line in FIG. 12. A hydrogen atom concentration profile of a glass article manufactured using an electric furnace as a related-art heater is referred to as a third profile, which is denoted by a reference symbol PR3 and indicated by the one-dot chain line in FIG. 12. A hydrogen atom concentration profile of a glass article (plain glass) before being molded by the superheated steam is referred to as a fourth profile, which is denoted by a reference symbol PR4 and indicated by the two-dot chain line in FIG. 12.

As shown in FIG. 12, the first profile PR1 comprises a first inclined portion IP1, a second inclined portion IP2 located in a range deeper than a depth of 1.5 μm, and a horizontal portion HP. The first inclined portion IP1 decreases in hydrogen atom concentration with respect to the depth direction. Thus, when the hydrogen atom concentration at the surface of the glass article and the hydrogen atom concentration at the depth of 1.5 μm from the surface of the glass article are compared with each other, the hydrogen atom concentration at the depth of 1.5 μm from the surface of the glass article is lower. The second inclined portion IP2 decreases in hydrogen atom concentration with respect to the depth direction. Thus, when the hydrogen atom concentration at the depth of 1.5 μm from the surface of the glass article and, for example, the hydrogen atom concentration at a depth of 10 μm from the surface of the glass article are compared with each other, the hydrogen atom concentration at the depth of 10 μm from the surface of the glass article is lower.

In the first inclined portion IP1 of the first profile PR1, the degree of decrease in the hydrogen atom concentration with respect to the depth direction (the value obtained by dividing the difference between the hydrogen atom concentration at the surface of the glass article and the hydrogen atom concentration at the depth of 1.5 μm from the surface of the glass article by 1.5 μm) is larger than that in the second inclined portion IP2 (value obtained by dividing the difference between the hydrogen atom concentration at the depth of 1.5 μm from the surface of the glass article and the hydrogen atom concentration at the depth of 10 μm from the surface of the glass article by 8.5 μm (10 μm-1.5 μm)). The horizontal portion HP is located in a range deeper than the second inclined portion IP2. The horizontal portion HP is a portion at which the hydrogen atom concentration is substantially the same in the depth direction in logarithmic representation (the absolute value of the logarithmic representation change amount of the hydrogen atom concentration per unit depth is 0.1 or less of the absolute value of the logarithmic representation change amount at a depth of 1.5 μm to 2.5 μm; the same applies hereinafter).

As shown in FIG. 12, in the second inclined portion IP2 of the first profile PR1, a portion in which the hydrogen atom concentration increases as the depth from the surface of the glass article is larger is absent. Further, in the second inclined portion IP2, the hydrogen atom concentration always decreases as the depth is larger.

In the first profile PR1, when the hydrogen atom concentration at the surface of the glass article and the hydrogen atom concentration at a depth of 2.0 μm from the surface of the glass article are compared with each other, the hydrogen atom concentration at the depth of 2.0 μm from the surface of the glass article is lower. Further, in the first profile PR1, the hydrogen atom concentration decreases also in a range deeper than the depth of 2.0 μm from the surface of the glass. In the first profile PR1, when the hydrogen atom concentration at the depth of 2.0 μm from the surface of the glass article and the hydrogen atom concentration at a depth of 10 μm from the surface of the glass article are compared with each other, the hydrogen atom concentration at the depth of 10 μm from the surface of the glass article is lower.

In the first profile PR1, when the hydrogen atom concentration at the surface of the glass article and the hydrogen atom concentration at a depth of 3.0 μm from the surface of the glass article are compared with each other, the hydrogen atom concentration at the depth of 3.0 μm from the surface of the glass article is lower. Further, in the first profile PR1, the hydrogen atom concentration decreases also in a range deeper than the depth of 3.0 μm from the surface of the glass. In the first profile PR1, when the hydrogen atom concentration at the depth of 3.0 μm from the surface of the glass article and the hydrogen atom concentration at a depth of 10 μm from the surface of the glass article are compared with each other, the hydrogen atom concentration at the depth of 10 μm from the surface of the glass article is lower.

The second profile PR2 comprises a first inclined portion IP1, a second inclined portion IP2 located in a range deeper than a depth of 1.5 μm, and a horizontal portion HP which is a portion in which the hydrogen atom concentration is substantially the same in the depth direction in logarithmic representation. The first inclined portion IP1 in the second profile PR2 is a portion in which the hydrogen atom concentration significantly decreases with respect to the depth direction in a range up to the depth of 1.5 μm. The second inclined portion IP2 of the second profile PR2 is a portion in which the hydrogen atom concentration increases with respect to the depth direction in a range deeper than the depth of 1.5 μm. In the second inclined portion IP2 of the second profile PR2, the hydrogen atom concentration increases up to a depth of 2.5 μm. Thus, the second profile PR2 does not comprise a second inclined portion IP2 in which the hydrogen atom concentration decreases with respect to the depth direction as in the first profile PR1. The hydrogen atom concentrations in the first inclined portion IP1 and the second inclined portion IP2 of the second profile PR2 are smaller than the hydrogen atom concentrations in the first inclined portion IP1 and the second inclined portion IP2 of the first profile PR1.

The third profile PR3 comprises a first inclined portion IP1, a second inclined portion IP2 located in a range deeper than a depth of 1.5 μm, and a horizontal portion HP which is a portion in which the hydrogen atom concentration is substantially the same in the depth direction in logarithmic representation. The first inclined portion IP1 in the third profile PR3 is a portion in which the hydrogen atom concentration significantly decreases with respect to the depth direction in the range up to the depth of 1.5 μm. The second inclined portion IP2 of the third profile PR3 is a portion in which the hydrogen atom concentration increases with respect to the depth direction in the range deeper than the depth of 1.5 μm. Thus, the third profile PR3 does not comprise a second inclined portion IP2 in which the hydrogen atom concentration decreases with respect to the depth direction as in the first profile PR1. The hydrogen atom concentrations in the first inclined portion IP1 and the second inclined portion IP2 of the third profile PR3 are smaller than the hydrogen atom concentrations in the first inclined portion IP1 and the second inclined portion IP2 of the first profile PR1.

The fourth profile PR4 comprises a first inclined portion IP1, a second inclined portion IP2 located in a range deeper than a depth of 1.5 μm, and a horizontal portion HP which is a portion in which the hydrogen atom concentration is substantially the same in the depth direction in logarithmic representation. The first inclined portion IP1 of the fourth profile PR4 is a portion in which the hydrogen atom concentration significantly decreases with respect to the depth direction in the range up to the depth of 1.5 μm. The second inclined portion IP2 of the fourth profile PR4 is a portion in which the hydrogen atom concentration increases with respect to the depth direction in the range deeper than the depth of 1.5 μm. Thus, the fourth profile PR4 does not comprise a second inclined portion IP2 in which the hydrogen atom concentration decreases with respect to the depth direction as in the first profile PR1. The hydrogen atom concentrations in the first inclined portion IP1 and the second inclined portion IP2 of the fourth profile PR4 are smaller than the hydrogen atom concentrations in the first inclined portion IP1 and the second inclined portion IP2 of the first profile PR1.

When the hydrogen atom concentration increases in the depth range in the vicinity of the surface of the glass article as in the first inclined portion IP1 and the second inclined portion IP2 in the first profile PR1, it is expected that the hardness of the glass in this range decreases as compared with the related-art glass article. When the hardness decreases as described above, for example, it is expected that fine scratches formed on the glass base material in a manufacturing process for the glass base material disappear due to softening and deformation of the glass base material in the molding step. Accordingly, the glass article with few scratches can be manufactured efficiently.

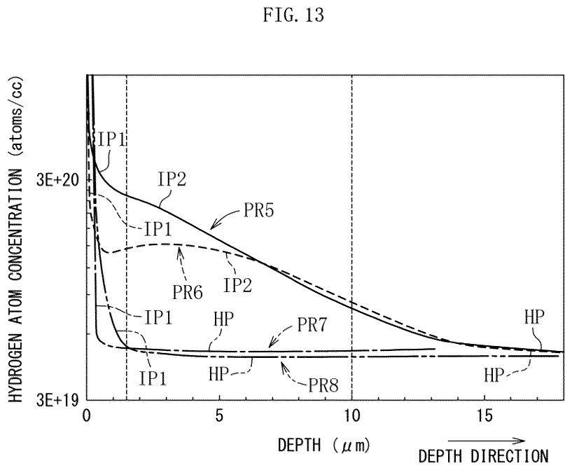

FIG. 13 is a graph for comparing the hydrogen atom concentration profile (superheated steam temperature of 900° C.) of the glass article according to the present invention (borosilicate glass BU-41 (manufactured by Nippon Electric Glass Co., Ltd.)), thickness of 0.7 mm, softening point of 700° C.) and a hydrogen atom concentration profile of a related-art glass article (borosilicate glass BU-41 (manufactured by Nippon Electric Glass Co., Ltd.)) to each other. In FIG. 13, the horizontal axis represents a depth (μm) from the surface of the glass article. “0” in the horizontal axis represents a position of the surface of the glass article (first surface formed through contact of the superheated steam Sx). In FIG. 13, the vertical axis represents a hydrogen atom concentration (atoms/cc) of the glass article, which is logarithmically represented.

In the following, the hydrogen atom concentration profiles of the glass articles manufactured by the present invention are referred to as a fifth profile and a sixth profile. In FIG. 13, the fifth profile is denoted by a reference symbol PR5 and indicated by the solid line, and the sixth profile is denoted by a reference symbol PR6 and indicated by the dot line. The glass article according to the sixth profile is obtained by subjecting the glass article according to the fifth profile to annealing treatment at 490° C. for 600 seconds by an electric furnace. The hydrogen atom concentration profile of the glass article (plain glass) before being molded by the superheated steam is referred to as a seventh profile, which is denoted by a reference symbol PR7 and indicated by the one-dot chain line in FIG. 13. The hydrogen atom concentration profile of the glass article obtained by subjecting the glass article according to the seventh profile to annealing treatment at 490° C. for 600 seconds by an electric furnace is referred to as an eighth profile, which is denoted by a reference symbol PR8 and indicated by two-dot chain line in FIG. 13.

As shown in FIG. 13, the fifth profile PR5 comprises a first inclined portion IP1, a second inclined portion IP2 located in a range deeper than a depth of 1.5 μm, and a horizontal portion HP. The first inclined portion IP1 decreases in hydrogen atom concentration with respect to the depth direction. Thus, when the hydrogen atom concentration at the surface of the glass article and the hydrogen atom concentration at the depth of 1.5 μm from the surface of the glass article are compared to each other, the hydrogen atom concentration at the depth of 1.5 μm from the surface of the glass article is lower. The second inclined portion IP2 decreases in hydrogen atom concentration with respect to the depth direction. Thus, when the hydrogen atom concentration at the depth of 1.5 μm from the surface of the glass article and, for example, the hydrogen atom concentration at a depth of 10 μm from the surface of the glass article are compared to each other, the hydrogen atom concentration at the depth of 10 μm from the surface of the glass article is lower. Further, the second inclined portion IP2 of the fifth profile PR5 extends from the surface of the glass article up to a depth of 16 μm.

In the first inclined portion IP1 of the fifth profile PR5, the degree of decrease in the hydrogen atom concentration with respect to the depth direction (value obtained by dividing the difference between the hydrogen atom concentration at the surface of the glass article and the hydrogen atom concentration at the depth of 1.5 μm from the surface of the glass article by 1.5 μm) is larger than that in the second inclined portion IP2 (value obtained by dividing the difference between the hydrogen atom concentration at the depth of 1.5 μm from the surface of the glass article and the hydrogen atom concentration at the depth of 10 μm from the surface of the glass article by 8.5 μm (10 μm-1.5 μm)). The horizontal portion HP is located in a range deeper than the second inclined portion IP2. The horizontal portion HP is a portion in which the hydrogen atom concentration is substantially the same in the depth direction in logarithmic representation (the absolute value of the logarithmic representation change amount of the hydrogen atom concentration per unit depth is 0.1 or less of the absolute value of the logarithmic representation change amount at a depth of 1.5 μm to 2.5 μm; the same applies hereinafter).

As shown in FIG. 13, in the second inclined portion IP2 of the fifth profile PR5, a portion in which the hydrogen atom concentration increases as the depth from the surface of the glass article is larger is absent. Further, in the second inclined portion IP2, as the depth is larger, the hydrogen atom concentration always decreases.

In the fifth profile PR5, when the hydrogen atom concentration at the surface of the glass article and the hydrogen atom concentration at a depth of 2.0 μm from the surface of the glass article are compared to each other, the hydrogen atom concentration at the depth of 2.0 μm from the surface of the glass article is lower. Further, the hydrogen atom concentration decreases also in a range deeper than the position at the depth of 2.0 μm from the surface of the glass article. In this embodiment, when the hydrogen atom concentration at the depth of 2.0 μm from the surface of the glass article and the hydrogen atom concentration at the depth of 10 μm from the surface of the glass article are compared to each other, the hydrogen atom concentration at the depth of 10 μm from the surface of the glass article is lower.

In the fifth profile PR5, when the hydrogen atom concentration at the surface of the glass article and the hydrogen atom concentration at a depth of 3.0 μm from the surface of the glass article are compared to each other, the hydrogen atom concentration at the depth of 3.0 μm from the surface of the glass article is lower. Further, the hydrogen atom concentration decreases also in a range deeper than the position at the depth of 3.0 μm from the surface of the glass article. In this embodiment, when the hydrogen atom concentration at the depth of 3.0 μm from the surface of the glass article and the hydrogen atom concentration at the depth of 10 μm from the surface of the glass article are compared to each other, the hydrogen atom concentration at the depth of 10 μm from the surface of the glass article is lower.

The sixth profile PR6 comprises a first inclined portion IP1, a second inclined portion IP2 located in a range deeper than a depth of 1.5 μm, and a horizontal portion HP which is a portion in which the hydrogen atom concentration is substantially the same in the depth direction in logarithmic representation. The first inclined portion IP1 in the sixth profile PR6 is a portion in which the hydrogen atom concentration significantly decreases with respect to the depth direction in a range up to the depth of 1.5 μm. The second inclined portion IP2 of the sixth profile PR6 comprises a portion in which the hydrogen atom concentration transits at a constant value with respect to the depth direction in a range deeper than the depth of 1.5 μm, and a portion in which the hydrogen atom concentration decreases with respect to the depth direction. That is, in the second inclined portion IP2 of the sixth profile PR6, the hydrogen atom concentration is substantially constant in a range from the depth of 1.5 μm to a depth of 5.0 μm. Specifically, the hydrogen atom concentration slightly increases in a range from the depth of 1.5 μm to a depth of 3.0 μm, and the hydrogen atom concentration slightly decreases in a range from the depth 3.0 μm to the depth of 5.0 μm. In the second inclined portion IP2, the hydrogen atom concentration decreases with respect to the depth direction in a range deeper than the depth of 5.0 μm. Thus, similarly to the fifth profile PR5, the sixth profile PR6 comprises the second inclined portion IP2 in which the hydrogen atom concentration decreases with respect to the depth direction.

The seventh profile PR7 comprises a first inclined portion IP1, and a horizontal portion HP which is a portion in which the hydrogen atom concentration is substantially the same in the depth direction in logarithmic representation. The first inclined portion IP1 of the seventh profile PR7 is a portion in which the hydrogen atom concentration significantly decreases with respect to the depth direction in a range up to the depth of 1.5 μm. The seventh profile PR7 does not comprise a second inclined portion IP2 in which the hydrogen atom concentration decreases with respect to the depth direction as in the fifth profile PR5 between the first inclined portion IP1 and the horizontal portion HP.

The eighth profile PR8 comprises a first inclined portion IP1, and a horizontal portion HP which is a portion in which the hydrogen atom concentration is substantially the same in the depth direction in logarithmic representation. The first inclined portion IP1 of the eighth profile PR8 is a portion in which the hydrogen atom concentration significantly decreases with respect to the depth direction in a range up to the depth of 1.5 μm. The eighth profile PR8 does not comprise a second inclined portion IP2 in which the hydrogen atom concentration decreases with respect to the depth direction as in the fifth profile PR5 between the first inclined portion IP1 and the horizontal portion HP.

When the hydrogen atom concentration increases in the depth range in the vicinity of the surface of the glass article as in the first inclined portion IP1 and the second inclined portion IP2 of each of the fifth profile PR5 and the sixth profile PR6, it is expected that the hardness of the glass in the range is lower than that in the related-art glass article. When the hardness decreases in this manner, for example, fine scratches formed on the glass base material in the manufacturing process for the glass base material disappear due to softening and deformation of the glass base material in the molding step. Accordingly, the glass article with few scratches can be manufactured efficiently.

Some embodiments of the present invention have been described above. Of course, however, the present invention is not limited to those embodiments, and various other embodiments are possible within the scope of the present invention.

In the above-mentioned embodiments, the case in which the superheated steam Sx is generated from the water W has been exemplified. However, the superheated steam Sx may be generated from fluids other than the water W.

In the above-mentioned embodiments, the case in which the glass sheet G is softened only by the superheated steam Sx has been exemplified. However, a heater configured to supplementarily heat an ambient atmosphere of the glass sheet G, or an auxiliary heater such as a heating mechanism configured to heat the lower die 3 in order to assist bending of the glass sheet G may be used in combination.

A shape of the lower die 3 is not limited to that exemplified in the above-mentioned embodiments, and may be appropriately changed in accordance with the shape of the bent portion Gy of the bent glass sheet Gx. For example, the case in which the molding surface 9 comprising the bending portion 10 forms the recessed portion as a whole has been exemplified. However, the molding surface 9 may form a protruding portion as a whole, or may have a shape in which a protruding portion and a recessed portion are combined with each other. Further, the bending portion 10 may have any shape in which a plurality of curved surfaces and/or flat surfaces (including inclined surfaces) are combined with each other.

In the above-mentioned embodiments, the case in which the glass sheet G is directly brought into contact with the lower die 3 has been exemplified. However, the present invention is not limited to this mode. For example, in order to prevent scratches from being formed on the glass sheet G, a protective sheet may be arranged on the lower die 3, and the glass sheet G may be arranged on the protective sheet. In this case, it is preferred that a material having heat resistance be selected as the protective sheet, and, for example, a polyimide sheet or a graphite sheet can be suitably used.

In the above-mentioned embodiments, with the own weight of the glass sheet G and the wind pressure of the superheated steam Sx and by selectively using suction from the lower die 3, bending of the glass sheet G is performed. However, the present invention is not limited to this mode. For example, when bending is performed on a complicated shape which is difficult to be subjected to bending only by the lower die 3, an upper die may be supplementarily used. In this case, it is preferred that, first, bending on the glass sheet G be performed with the own weight of the glass sheet G and the superheated steam Sx, and after that, as a final process, the upper die be supplementarily used to perform bending on the glass sheet G. In this case, it is preferred that the superheated steam be jetted also from the upper die.

In the above-mentioned embodiments, the example in which the cover member 8 is arranged between the lower die 3 and the jet port 5a in the transfer pipe 5 of the superheating device 6 to execute the molding step has been described. However, the present invention is not limited to the configuration, and the cover member may be omitted.

### REFERENCE SIGNS LIST

1 manufacturing apparatus for glass article
3 lower die
5a jet port
9 molding surface
13 side stopper (lateral displacement restricting mechanism)
14 placement surface
18 suction hole
22 first suction hole
23 second suction hole (lateral displacement restricting mechanism)
24 pressing member (lateral displacement restricting mechanism)
25 mask member
25a through hole
27 space portion
27a opening
28 heating furnace
ED1 opening edge of lower die
ED2 inner peripheral edge of through hole
G glass sheet (glass base material)
Gx bent glass sheet (glass article)
Gy bent portion
IP1 first inclined portion
IP2 second inclined portion
PR1 first profile (hydrogen atom concentration profile)
S saturated steam
Sx superheated steam

1. A method of manufacturing a glass article, comprising a molding step of heating a glass base material with a superheated steam to soften the glass base material, and deforming the softened glass base material.

2. The method of manufacturing a glass article according to claim 1, wherein, in the molding step, the glass base material is deformed by a wind pressure of the superheated steam.

3. The method of manufacturing a glass article according to claim 1, wherein the superheated steam is jetted in a range wider than a portion of the glass base material which is to be deformed.

4. The method of manufacturing a glass article according to claim 1, wherein a temperature of the superheated steam is equal to or more than a softening point of the glass base material.

5. The method of manufacturing a glass article according to claim 1, further comprising an arranging step of arranging the glass base material on a lower die before the molding step,
wherein the lower die comprises a placement surface configured to support the glass base material, and a space portion configured to allow deformation of a part of the glass base material,
wherein the space portion comprises an opening surrounded by the placement surface, and
wherein, in the molding step, under a state in which the glass base material is supported by the placement surface, the superheated steam is jetted onto the glass base material from above the lower die to soften a part of the glass base material located within a range of the opening, and the softened part is deformed due to the own weight of the softened part.

6. The method of manufacturing a glass article according to claim 5,
wherein the arranging step comprises a step of overlaying a mask member on the glass base material arranged on the placement surface of the lower die,
wherein the mask member comprises a through hole, and
wherein, in the step of overlaying the mask member on the glass base material, the mask member is overlaid on the glass base material such that an inner peripheral edge of the through hole is located on an inner side with respect to an opening edge of the lower die.

7. The method of manufacturing a glass article according to claim 1, further comprising an arranging step of arranging the glass base material on a lower die before the molding step,
wherein the lower die comprises a molding surface configured to mold the glass base material, and
wherein the molding surface is configured to jet the superheated steam in the molding step to soften the glass base material, and then, to suck the glass base material.

8. The method of manufacturing a glass article according to claim 7, wherein the lower die is controlled in temperature.

9. The method of manufacturing a glass article according to claim 8, wherein the lower die is controlled in temperature to a softening point of the glass base material or less.

10. The method of manufacturing a glass article according to claim 7,
wherein the lower die comprises a restricting mechanism configured to restrict lateral displacement of the glass base material, and
wherein the glass base material is deformed under a state in which the lateral displacement of the glass base material with respect to the lower die is restricted by the restricting mechanism.

11. The method of manufacturing a glass article according to claim 10,
wherein the lower die comprises a placement surface on which a part of the glass base material is to be placed, and
wherein the restricting mechanism sucks a part of the glass base material by the placement surface to fix the glass base material.

12. The method of manufacturing a glass article according to claim 10,
wherein the lower die comprises a placement surface on which a part of the glass base material is to be placed, and
wherein the restricting mechanism presses a part of the glass base material against the placement surface by a pressing member to fix the glass base material.

13. The method of manufacturing a glass article according to claim 1, wherein, in the molding step, the glass base material arranged in a heating furnace is softened with the superheated steam supplied into the heating furnace, and the softened glass base material is deformed.

14. A glass article having a surface, wherein a hydrogen atom concentration profile obtained by measuring a hydrogen atom concentration in a depth direction from the surface comprises an inclined portion that decreases in the hydrogen atom concentration with respect to the depth direction in a range in which the depth is larger than 1.5 μm.

15. The glass article according to claim 14, wherein, in a range up to a depth of 1.5 μm from the surface, the hydrogen atom concentration profile comprises an inclined portion in which a degree of decrease in the hydrogen atom concentration with respect to the depth direction is larger than in the inclined portion.

16. The glass article according to claim 14, wherein the surface comprises a bent portion, and in at least the bent portion, a hydrogen atom concentration profile obtained by measuring a hydrogen atom concentration in the depth direction from the surface comprises an inclined portion in which the hydrogen atom concentration decreases with respect to the depth direction in a range in which the depth is larger than 1.5 μm.
